(19) United States
(12) Patent Application Publication
(10) Pub. No.: US 2004/0153347 A1
(43) Pub. Date: Aug. 5, 2004

(54) Method and apparatus for point-of-sale purchasing

(76) Inventors: David Kunze, Stevens Point, WI (US); Srinivas Jasthi, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/758,922

(22) Filed: Jan. 16, 2004

Related U.S. Application Data
(60) Provisional application No. 60/443,905, filed on Jan. 31, 2003.

(51) Int. Cl. G06F 17/60

(52) U.S. Cl. 705/4; 705/5

(57) ABSTRACT

A software package is provided for monitoring data entered into a travel reservation booking software. Upon detection of a predetermined data entry sequence, the software package launches a routine to remind the agent to inquire as to whether the traveler wishes to purchase travel insurance. If travel insurance is desired, the software package provides an interface to a web server over the internet and pre-populates a data fields at the web server using previously monitored data. Once data entry is completed at the web server, the software package populates the booking software with data entered at the web server.

### CROSS-REFERENCE TO RELATED APPLICATIONS

This claims the benefit of U.S. Provisional Patent Application No. 60/443,905 filed Jan. 31, 2003.

### STATEMENT REGARDING FEDERALLY SPONSORED RESEARCH OR DEVELOPMENT

### BACKGROUND OF THE INVENTION

The present invention relates generally to computer software-based pop-up displays and more particularly relates to a software program that monitors input data in real-time to selectively initiate an interactive purchase display.

Conventional global distribution systems (GDS) and computer reservation systems (CRS) are widely known as “legacy” mainframe computer systems that provide access to travel related suppliers and vendors. For the sake of clarity and convenience, GDS and CRS systems are collectively identified in a non-limiting manner throughout this disclosure synonymously as GDS, and more generically referred to as travel reservation purchase routines.

In general, a GDS can be selected from a collection of well-known systems (namely Sabre, Abacus, Amadeus, Galileo/Apollo, and Worldspan) used by travel agents for booking travel reservations, such as tours, cruises, and airline tickets for travelers worldwide. The GDS system is text based and requires the operator to learn a set of cryptic data entry codes and protocol for entering passenger and travel-related data, known as passenger name records (PNR). Examples of various data entry fields for the Worldpsan system are illustrated in Table 1.

TABLE 1

| PNR TYPE | DATA ENTRY CODE |
|---|---|
| Specific Date | T:TAU/9JUL |
| Date and Comment | T:TAU/9JUL/FREEFORM |
| Date at Branch Office | T:TAU/8AUG@CA3 |
| Agent PCC and Branch PCC | T:TAU/1MAY/3MAY@CA3 |
| Date/Comment at Branch Office | T:TAU/8AUG@CA3/FREEFORM |
| Date and Multiple-Queue Placement (Max of 6) | T:TAU/9JUL/1JULQ5/8JUNQ4 |
| Date and Multiple Queue and Queue Category | T:TAU9JUL/1JULQ7*CCT |
| Placement | |
| House Account (Min 6 Char.) | T:TAW/28JUL-ACMECO |
| House Account with Time | T:TAW/28JUL-ACMECO-3P |
| | OR |
| | T:TAW/28JUL-3P-ACMECO |
| House Account..Time/Comment | T:TAW/8JUL-ACME-9A/DLVR |
| Specific Date and Queue Placement at Branch | T:TAW/9JULACMECO@CA3/8JUNQ15/10JULQ14 |
| Office | |
| House Account with Time at a Branch Office | T:TAW/28JUL-ACME-9A@CA3 |
| House Account with Time and Queue Placement | T:TAW/28JUL-ACMECO-3P/2JULQ43 |
| (Max of 6) | |
| Specific Airport/Carrier/Time | T:TLORD/TW900A/1JUL |
| 30 Minutes for UA | T:TL30 |
| Follow-up and Place on Queue 12 | T:TL800A/2JUL/CK.SEATS |
| Passenger Ticketed | T:T/ |

It should be appreciated that the data entry codes above are merely examples of the types of codes used in a GDS, and the present invention is not to be limited to those specifically identified herein. Rather, the examples in Table 1 are set forth to illustrate examples of the data entry codes that are used when booking a travel reservation. Because of the difficulty posed to the travel agent in learning the data entry codes, and the time-consuming nature of entering the codes, a travel agent may spend a significant amount of time typing when completing a sale.

Due to the elimination of airline commissions in 2002, along with overall cuts to the base commissions paid by most travel suppliers to travel agencies, travel agencies have sought ways to reduce the length of time needed to complete a travel purchase. Agencies further encourage their agents to sell products that result in higher commissions, such as travel insurance.

What is therefore desirable is a method and apparatus for automatically reminding agents operating a GDS to offer travel insurance when appropriate. It would further be desirable to automatically update the PNR when such products are sold without requiring substantial data entry on the part of the travel agent.

### BRIEF SUMMARY OF THE INVENTION

In accordance with one aspect, of the invention, a method is provided for facilitating travel insurance sales on a computer system that is receiving data during a travel reservation purchase routine. The method includes the steps of monitoring data streams of at least one data sequence relevant to the travel reservation purchasing routine, and identifying a predetermined data stream in the data sequence. Once the predetermined data stream has been identified, a travel insurance purchase routine is executed. The routine includes the steps of 1) launching at least one form with data fields that are to be completed related to purchasing travel insurance; and 2; populating at least a portion of the data fields with data previously entered during the travel reservation purchase routine. A travel insurance policy is then generated.

These and other aspects of the invention are not intended to define the scope of the invention for which purpose claims are provided. In the following description, reference is made to the accompanying drawings, which form a part hereof, and in which there is shown by way of illustration, and not limitation, a preferred embodiment of the invention.

### BRIEF DESCRIPTION OF THE DRAWINGS

Reference is hereby made to the following drawings in which like reference numerals correspond to like elements throughout, and in which:

FIG. 1 is a schematic diagram of a workstation suitable for use with the preferred embodiment of the invention;

FIG. 2 is a logical diagram of the communications of software components installed at the workstation illustrated in FIG. 1;

FIG. 3 is a flow chart illustrating operation of a preferred embodiment of the invention;

FIG. 4A is a flow chart illustrating the steps of an insurance purchase routine in accordance with the preferred embodiment;

FIG. 4B is a flow chart illustrating the steps of the insurance purchase routine in accordance with an alternate embodiment of the invention;

FIG. 5 is an illustration of a first screen generated when offering travel insurance in accordance with the preferred embodiment;

FIG. 6 is an illustration of a pre-populated second screen generated when travel insurance is desired in accordance with the preferred embodiment;

FIG. 7 is an illustration of a third screen offering various travel insurance packages in accordance with the preferred embodiment;

FIG. 8 is an illustration of a fourth screen including an insurance cost calculator in accordance with the preferred embodiment;

FIG. 9 is an illustration of a fifth screen including a travel insurance application in accordance with the preferred embodiment;

FIG. 10 is an illustration of a sixth screen including payment fields in accordance with the preferred embodiment;

FIG. 11 is a sixth screen illustrating the issued travel policy in accordance with the preferred embodiment; and

FIG. 12 is a schematic illustration of a travel insurance database in accordance with the preferred embodiment.

### DETAILED DESCRIPTION OF THE PREFERRED EMBODIMENT

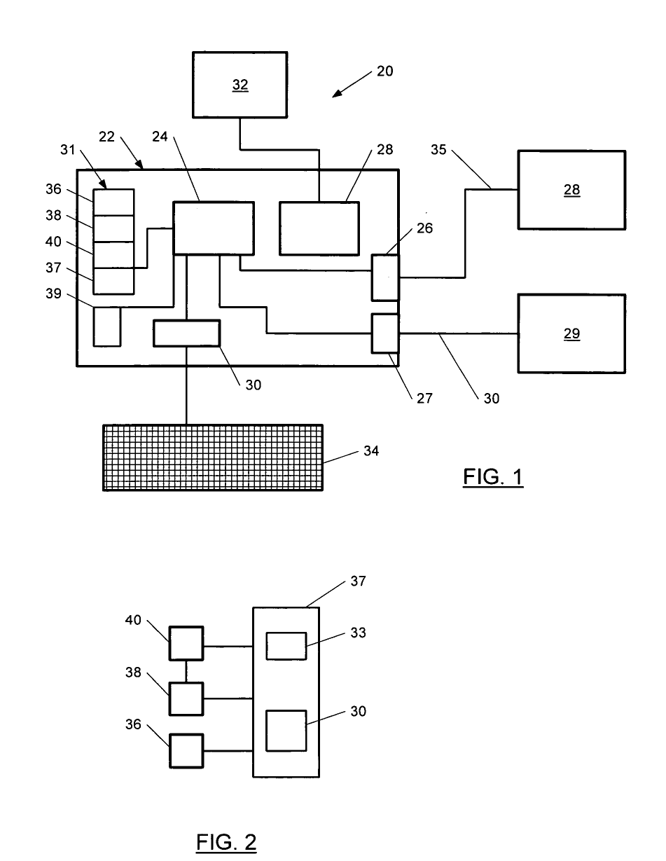

Referring to FIG. 1, the present invention can be implemented on a workstation 20 including a personal computer 22 having a central processing unit (CPU) 24. Processor 24 is in communication with a first network interface circuit 26 communicating over a network 35 with a mainframe computer 28, and with a second network interface circuit 27 communicating over the Internet 30 with a web server 29. The CPU 24 is further in communication with a video driver 28, a keyboard interface 33, a nonvolatile memory device 31, and a volatile memory device 39. The video driver 28 is, in turn, connected to a display 32 that receives video data from driver 28 and produces video output that is displayed to the user. The keyboard interface 33 receives input from a human/machine interface (HMI), such as keyboard 34 and/or mouse (not shown), and forwards the input data to processor 24. Nonvolatile memory device 31 stores an application program, such as a GDS 36, a conventional operating system 37, web browser 38, along with other software and data as known by those skilled in the art. A software package 40 constructed in accordance with the principles of the present invention is preferably installed on the computer 22 locally and stored in memory 31 as illustrated, or is alternatively programmed on a central server (not shown) and executed by computer 22 communicating over a network. Volatile memory 39 can be a Random Access Memory (RAM) for temporarily storing data.

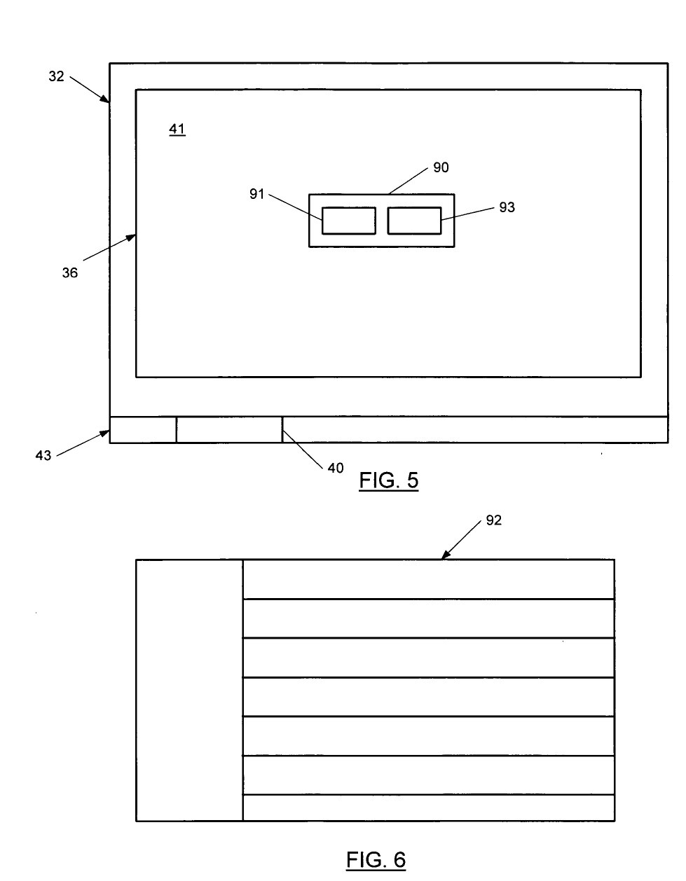

Referring also to FIG. 5, operating system 37 is preferably a Windows® based system. Accordingly, display 32 can be a monitor including an active screen 41 including a GDS 36, and a taskbar 43. The term “GDS” is used herein to describe a system describing both a global distribution system and a computer reservation system “CRS” which are used by a travel agent when booking a travel reservation. It should be appreciated, however, that the principles of the present invention are not necessarily limited to GDS, but can apply to any computer program being executed on a computer 22 or workstation 20. Typically, information related to the identification of the travelers, travel itinerary, miscellaneous purchases (e.g., hotels, rental cars, etc.), and payment information are stored in the PNR and collected by the GDS. The most common GDS systems are conventionally sold under the trade name designations of Sabre (Abacus in Southeast Asia), Amadeus, Galileo/Apollo, and Worldspan.

Referring now to FIG. 2, the communication of various components of computer 22 is schematically illustrated. In particular, the GDS 36 and software application 40 are both independently in communication with operating system 37. Software application 40 is in communication with the web browser 38, and operating system 37 is in communication with keyboard interface 33 and the Internet 30 via processor 24.

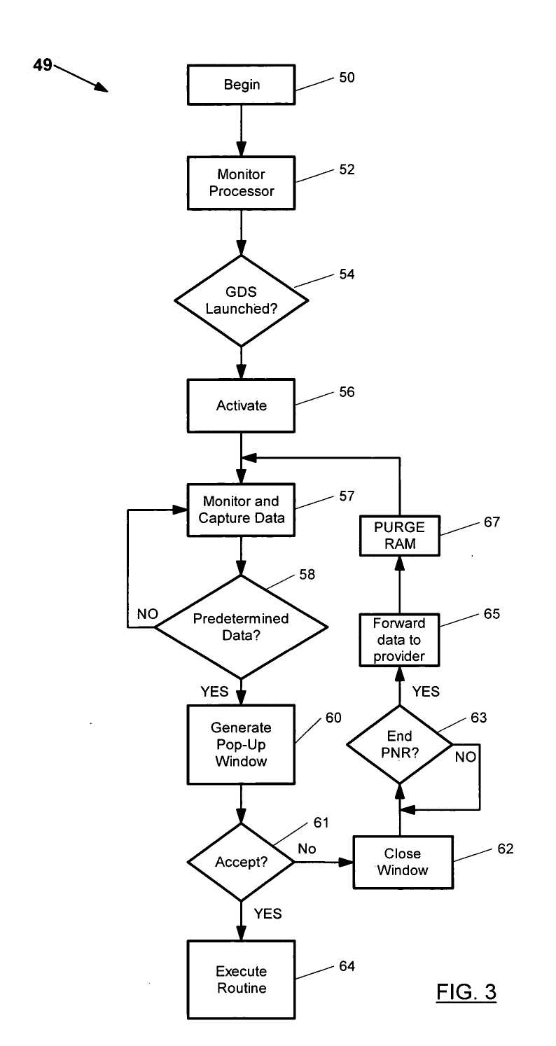

The method of operation 49 of software application 40 will now be described in greater detail with reference to FIG. 3. Method 49 begins at step 50, where the software application is launched manually by the user or, more preferably, automatically launched upon start-up of processor 24 (i.e., when the computer 22 is first turned on). At step 52, software 40 runs in the background and monitors the processor 24 to detect the initiation of GDS 36. At decision block 54, it is determined whether the GDS has been launched. If not, software 40 continues to monitor the processor 24. Once software 40 detects that the GDS 36 has been launched at decision block 54, the software 40 becomes active at step 56 and runs in the background in parallel with the GDS 36. Software 40 preferably resides on the taskbar of the user's display 32.

During operation of the GDS, the keyboard interface 33 receives data input in the form of keystrokes entered by the user at keyboard 34 and places that data in a keyboard buffer (not shown), which can be part of or separate from interface 33. The keyboard buffer is maintained by the operating system 37 and is readable and writable by all applications running on the computer, despite the fact that the applications may themselves be incompatible. Because the GDS uses the input data to update the PNR when booking a travel reservation, data input to the GDS can be used to identify progress that has been made when booking a travel reservation.

Accordingly, at step 57, software 40 monitors the data input via keyboard interface 33, and stores data pertaining to a particular PNR in RAM 39. Software 40 can store all data entered or, alternatively, can only store predetermined fields of data that will be used during subsequent steps, as will be described in more detail below. Software 40 preferably includes any Applet, preferably a Java Applet or an Active X/VB Applet, or any alternative apparatus suitable for monitoring data input via keyboard interface 33. By tracking all data entered into the GDS, software 40 can identify a predetermined word or sequence of keystrokes that signifies a particular point during the travel reservation booking process indicating that the traveler is likely to make a travel-related purchase.

At decision block 58, software determines whether the predetermined data has been entered, which can be any word sequence (at any point in time during the completion of the PNR) in accordance with the present invention. However, because the software package 40 is designed to sell travel insurance, the most desirable point in time to launch window 90 occurs once the travel reservation sequence has progressed to the point that the traveler is ready to complete the travel sale and ripe to purchase travel insurance. In accordance with the preferred embodiment, software 40 recognizes a predetermined PNR data code, for example corresponding to “form of payment” at decision block 58, thereby signifying that the traveler is ready to complete the sale. Examples of alternative data entry in the PNR that may be pre-selected to launch window 90 may correspond to printing an itinerary, printing a ticket, or other data entry sequences as appreciated by one having ordinary skill in the art.

Referring also to FIG. 5, once the predetermined data has been entered, method 49 advances from decision block 58 to step 60, where a pop-up window 90 is launched in the active screen portion 41 of display 32 that reminds the travel agent to offer travel insurance to the traveler. In particular, window 90 queries whether the traveler wishes to purchase travel insurance at step 60, and provides “accept” and “decline” icons 91 and 93, respectively, which can be “hotlinks” that are selectable by the agent via a mouse or like data input device. The “accept” icon 91 is selected if the traveler wishes to purchase travel insurance from the provider of software 40. The “decline” icon 93 is selected if the traveler does not wish to purchase travel insurance from the provider.

If insurance is declined, window 90 is closed at step 62, and the agent completes the PNR. A secondary confirmation window (not shown) may optionally be activated in the display 41 upon selection of the “decline” icon 93 at step 62. The secondary window queries whether the traveler does not wish to purchase any travel insurance, or whether the traveler is obtaining travel insurance from a different travel insurance provider. Alternatively, a third icon can be included in window 90 that queries whether the traveler is purchasing insurance from another provider.

If insurance is declined, a notice can also be placed on the itinerary and the invoice provided to the customer that the traveler has been offered, and has declined travel insurance. The notice can include contact information of the insurance provider in the event that the traveler wishes to purchase insurance in the future. Next, at decision block 63, software 40 determines whether the current PNR, for which travel insurance was declined, has been completed based on the data input to keyboard interface 33.

If so, software 40 advances to step 65, and launches web browser 38 and forwards data over the Internet 30 to the web server 29 of the travel insurance provider. The forwarded data can include information related to the declined travel insurance, including the identification of the travel agency, travel agent, type of travel purchased, and whether the traveler elected to purchase travel insurance from another provider. Data compiled at server 29 regarding travel insurance policies offered can be organized into a database, as will be described in more detail below.

Next, at step 67, software 40 clears RAM 39 of all data previously stored at step 56 for the previous PNR at step 67 and proceeds to step 57, whereby data pertaining to the next PNR is monitored and stored in RAM 39. A notice may also be placed on the itinerary and the invoice provided to the customer, along with contact information of the travel insurance provider.

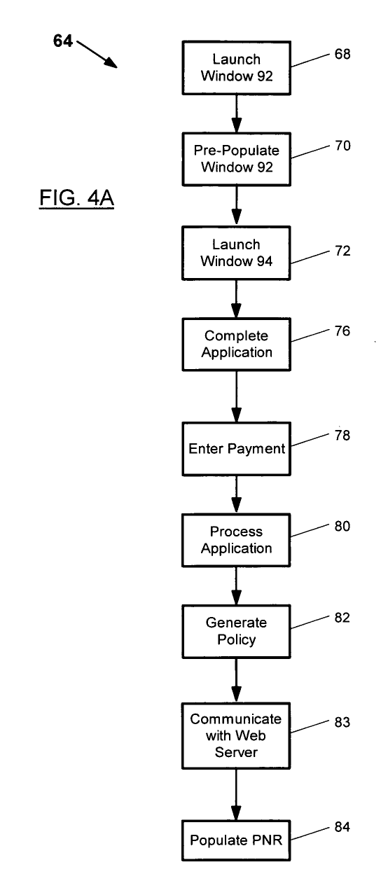

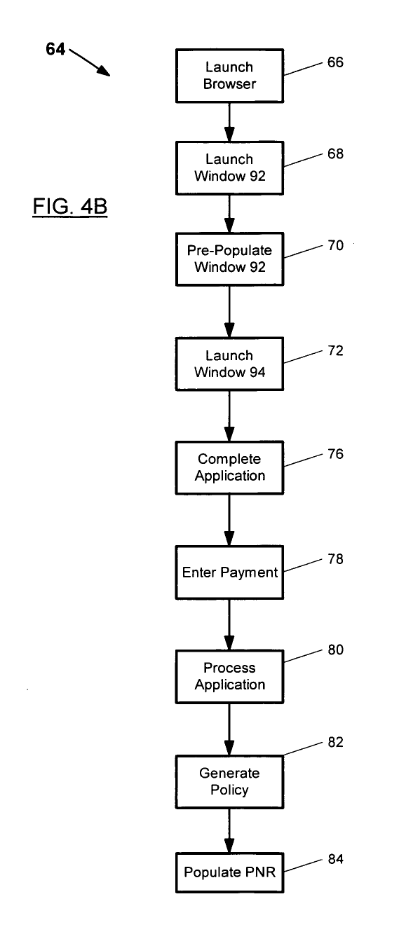

If the user chooses to accept travel insurance at decision block 61, the travel agent selects the “Accept” icon 91 and software 40 executes a “purchase travel insurance” routine 64. Referring to FIG. 4A, and also to FIG. 6, routine 64 begins at step 66, whereby software 40 launches a window 92 presenting a form including a plurality of fields that are to be completed. For instance, the fields include identification information for each traveler, along with the credit card or other purchasing information for the primary traveler, and itinerary information for the travel package. It should be appreciated, however, that credit card information could be entered at other steps during routine 64, as described in more detail below.

Software 40 identifies data, stored in RAM 39, that was previously entered into the PNR by the travel agent when booking the travel reservation. Software then captures the previously entered data that is also suitable for completing data fields in window 92, and pre-populates that data into the appropriate fields of window 92 at step 70. Accordingly, window 92 is partially completed when presented to the travel agent, thereby avoiding the need to enter data redundantly. As a result, when window 92 is displayed, the travel agent need only verify the pre-populated data, make necessary modifications, and enter only that data needed to complete window 92 that was not previously entered during the travel reservation booking process.

For instance, the agent then may either enter the payment information of the traveler at the appropriate fields of window 92, which preferably includes the traveler's credit card information, or alternatively may wait until an insurance package is selected before entering the payment information. Alternatively, if software 40 is configured to launch window 90 after the traveler's credit card information is entered in the PNR, window 92 could also be pre-populated with the traveler's credit card information, and require the travel agent only to verify the completed data in window 92.

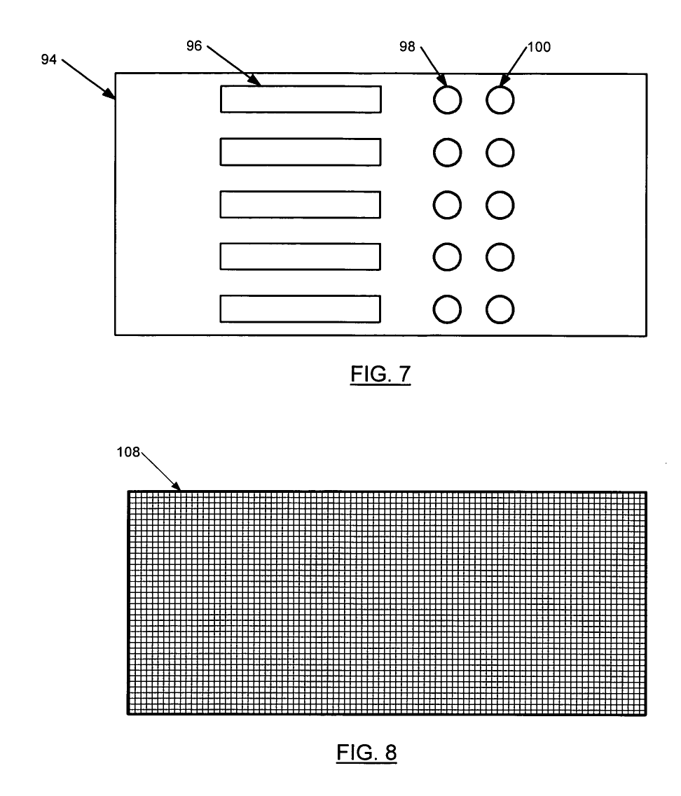

Referring now also to FIG. 7, once the data fields in window 92 have been completed, routine 64 advances to step 72, whereby a window 94 is generated and displayed to the travel agent. Window 94 presents several possible travel insurance packages 96 that a user may wish to purchase depending upon his/her individual needs based, at least in part, on the nature of the travel reservation (e.g., cruise, flight, hotel, car rental). Next to each option 96 is a help link 98 that can be selected by the agent and provides an easy and convenient interface to obtain a description of the corresponding travel option along with a pricing link 100. If the pricing link 100 is selected, a calculator 102 is launched that the agent can use to determine the price of the insurance package being purchased, as illustrated in FIG. 8.

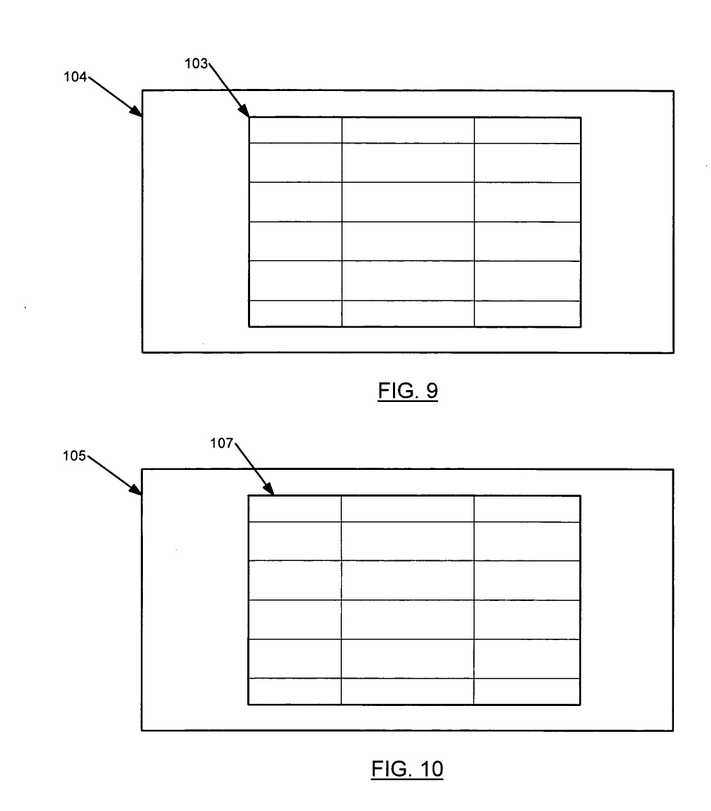

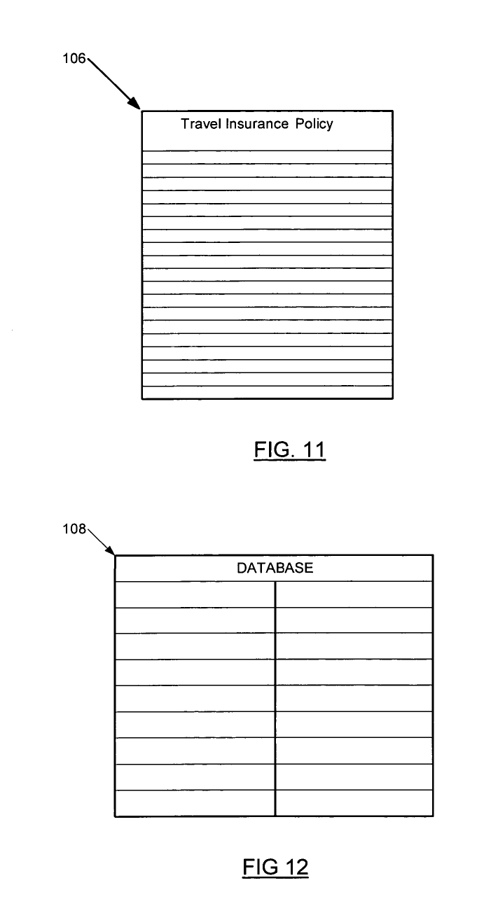

Once the pricing has been completed, routine 64 advances to step 76, whereby a window 104 is generated, and provides the formal application 103 for travel insurance, as illustrated in FIG. 9. The application can include data fields regarding the identification of each passenger being insured. The information previously captured regarding the primary traveler can be pre-populated in window 104. The remaining information needed for the application is manually entered by the travel agent. Next, at step 78, if the credit card information was not previously entered at window 92, a payment window 105 can be launched that enables the travel agent to enter the traveler's payment information 107, as illustrated in FIG. 10. Once the payment information is entered, software 40 processes the application at step 80. At step 82, the insurance policy 106 is generated and displayed as illustrated in FIG. 11.

At step 83, software 40 launches the web browser 38 in the background, and establishes a connection with the web server 29 over the Internet 30. If the agent's computer 22 is not currently connected to the Internet, the software 40 can provide a reminder for the agent to open a connection. Otherwise, software can automatically wait until the next instance that computer 22 is connected to the Internet to perform step 83. Once web server 29 has been successfully accessed, software 40 uploads information related to the travel insurance package, including a travel agent identification code, type of insurance purchased, cost of insurance, and commission earned by the travel agency from the insurance sale.

As a result, the travel insurance provider will be notified whether travel insurance was purchased or not (and if not, whether the traveler purchased insurance from another vendor) for every travel package purchased. If an insurance package is purchased, the information provided to the web server 29 can be used by the insurance provider to log the insurance purchase.

Referring now to FIG. 12, the insurance provider can also create a travel insurance policy database 108, based on information provided from software 40 to web server 29 pertaining to the travel insurance (if any) that was purchased. In one embodiment, software package 40 may also record statistical data related to the insurance sales. For instance, software 40 may track the number of instances that travel insurance was offered along with the number of instances that insurance was accepted or declined and, if accepted, which insurance packages were purchased.

Database 108 can reside directly on the web server 29, or on a computer that is accessible by the web server. Accordingly, database 108 can be accessed by each agency operating software 40 by accessing web server 29. In particular, agents of a given travel agency can enter the agent's or agency's authorization code and password to authenticate the identify of the party requesting information. Server 29 can then provide a statistical summary for the inquiring party, which can include the number of travel reservations sold, the number of travel insurance packages sold, total commissions earned from the sale of travel insurance packages, and commissions lost from travel insurance packages that were not purchased. The accounting statistics can be further broken down by agent within the agency to identify those salespersons that were most efficient in selling travel insurance packages. The agency can further request that the accounting statistics be provided over a predetermined period of time. Database 108 therefore enables individual agencies to track their insurance sales and performance of their individual agents.

Finally, at step 84, software 40 identifies which GDS system (for example Sabre, Amadeus, Apollo etc.) is being used for the travel reservation, and populates the PNR with travel insurance-related data that was previously entered during the travel insurance purchase routine 64. For instance, at step 84, accounting information obtained during routine 64 (such as the insurance policy number, travel insurance price, or any other information entered during routine 64) can be populated into the PNR at the appropriate data entry fields. It should be appreciated that the various GDS systems use on slightly different protocol for data entry. Software 40 uses the GDS identity to determine whether the GDS being used is compatible with the software. If so, the data can be uploaded directly into the PNR. Otherwise, the data can be sent to the keyboard interface 33 in the form of simulated keystrokes that are read by the GDS system.

Referring now to FIG. 4B, steps for performing routine 64 are illustrated in accordance with an alternate embodiment of the invention that is similar to the steps illustrated in FIG. 4A. However, in FIG. 4B, routine 64 begins at step 66, whereby software 40 launches web browser 38, which is connected to web server 29 via Internet connection 30. The agent can input the agent's or agency's identification code so that the insurance provider recognizes the travel agency that is completing the insurance sale and can therefore update the database 108 appropriately in the manner described above. The web sever 29 then launches window 92 as an applet, which is completed by the travel agent in the manner described above with reference to FIG. 4A, the difference being that the window 92 is executed on the web server 29 as opposed to locally on software 40. Steps 70-82 are also completed in the manner described above, with the various windows residing on the web server 29. Because information entered by the agent into the various windows is automatically forwarded to web server 29, step 83 of FIG. 4A is eliminated in FIG. 4B as server 29 can automatically capture data that is to be stored in database 108.

It should be appreciated in accordance with an alternate embodiment of the invention that certain windows 92, 94, 102, 104, and 105 can be launched directly by software 40, while others can be launched at the web server 29. Accordingly, unless otherwise specified, the various travel insurance purchase-related windows are not to be construed as limited to being executed locally on software or web server 29, but should be interpreted broadly as any window that 1) is configured to receive travel insurance related information using data previously entered into the PNR; and 2) can be used to populate the PNR once the travel insurance package has been purchased. Information entered locally on computer 22 that is necessary for producing database 108 can be uploaded to web server 29 in the manner described above.

Once the policy has been generated at step 82, routine 64 advances to step 84, whereby software 40 identifies the GDS system being used on computer 22, and forwards that information to the web server 29. Based on the GDS system, server 29 customizes the data into PNR data compatible with the GDS system. Software 40 receives the data from server 29, and enters the data into the GDS in the manner described above.

Accordingly, software 40 advantageously provides an interface between the GDS system and the travel agent to provide a user-friendly method and apparatus for reminding the travel agent to offer travel insurance to the traveler, and for declining or accepting the travel insurance. If accepted, the system then provides a windows-based interface for the entering data pertinent to the travel insurance package. It is further advantageous that data previously entered into the PNR is pre-populated into the insurance application data fields, thereby increasing the data entry efficiency compared to conventional systems, which require that data previously entered during the travel reservation process be re-entered when purchasing travel insurance. It is further advantageous that the travel insurance purchase routine is not launched until 1) sufficient data has been entered into the PNR to indicate that the prospective traveler will indeed be purchasing a travel reservation and 2) a sufficient amount of data has been entered to enable the travel insurance application to be substantially pre-populated with data. It is further advantageous that software 40 populates the PNR with data entered during the insurance purchase routine to avoid redundant and time-consuming data entry. It is further advantageous that the methods described herein can be performed regardless of the compatibility between software 40 and the particular GDS being run on the travel agent's workstation 20. It is further advantageous that the software 40 can communicate travel insurance-related data to a central web server which, in turn, produces a database that can be accessed by an individual travel agency to view statistical information related to that agency's success in selling the insurance.

The present invention thus solves a long-felt need in the travel industry for automatically encouraging high-commission sales while reducing time and effort on the part of the travel agent.

It should be appreciated, however, that the principles of the present invention are applicable beyond the travel insurance industry, and can be used to enhance the real-time sale of any product or service. In particular, the principles of the present invention are equally applicable to other industries that would benefit by a software program of the present invention that is operable to automatically monitor data in real-time and run a process upon detection of a predetermined data entry sequence. Alternatively, or in addition to launching the operating sequence based on input data, the software can monitor the video driver 28 or any other data sequence between the data input and output for a predetermined data stream that indicates the timing is appropriate for the process to be launched. For instance, method 49 could advance from decision block 58 to step 60 if the video driver sends signals to the display 32 indicating that the data corresponding to the predetermined PNR code has been entered. Accordingly, unless otherwise indicated, the term “data sequence” is not intended to be limited to monitoring input data, but can include any data between the input and the output that results, at least in part, from the input data.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

We claim:

1. A method for facilitating travel insurance sales on a computer system that is receiving data during a travel reservation purchase routine, the method comprising the steps of:
(A) monitoring data streams of at least one data sequence relevant to the travel reservation purchasing routine;
(B) identifying a predetermined data stream in the data sequence;
(C) after step B, executing a travel insurance purchase routine, including:
i. launching at least one form with data fields that are to be completed related to purchasing travel insurance; and
ii. populating at least a portion of the data fields with data previously entered during the travel reservation purchase routine; and
(D) outputting a travel insurance policy.

2. The method as recited in claim 1, wherein the data sequence is input data.

3. The method as recited in claim 2, wherein the data sequence is text data related to a legacy mainframe computer system.

4. The method as recited in claim 3, wherein the computer system includes a processor, a data entry device, and an interface between the entry device and the processor, wherein step (A) further comprises monitoring the interface.

5. The method as recited in claim 3, wherein the computer system comprises at least one of a Global Distribution System and a Computer Reservation System.

6. The method as recited in claim 5, wherein data streams further comprise PNR data.

7. The method as recited in claim 1, wherein step (A) further comprises storing the data streams in memory.

8. The method as recited in claim 1, wherein the predetermined data stream indicates a likelihood that a travel reservation will be finalized.

9. The method as recited in claim 1, wherein step (C) further includes launching a window offering an option to purchase travel insurance.

10. The method as recited in claim 1, wherein step (C) includes generating the form locally at the computer system.

11. The method as recited in claim 10, further comprising establishing a connection with a web server over the Internet, and forwarding data related to the travel insurance purchase routine to the web server.

12. The method as recited in claim 1, wherein step (C) includes establishing a connection with a web server over the Internet, and generating the form remotely at the web server.

13. The method as recited in claim 12, further comprising forwarding information related to the travel insurance purchase routine to the web server.

14. The method as recited in claim 1, further comprising the step of:
(E) after step (D), returning to the travel reservation purchase routine.

15. The method as recited in claim 14, wherein step (E) includes populating data entered during the travel insurance purchase routine into the travel reservation purchase routine.

16. The method as recited in claim 15, wherein the populated data includes accounting information.

17. The method as recited in claim 16, wherein the data populated into the travel reservation purchase routine includes information related to travel insurance purchased.

18. The method as recited in claim 1, wherein step (C) further comprises populating data fields with information regarding at least one of 1) an identity of one of the purchasers and 2) details related to the travel reservation.

19. The method as recited in claim 1, wherein step (C) further comprises the step of offering multiple insurance “products to select from to” purchase.

20. The method as recited in claim 1, wherein step (C) further comprises providing an option to accept or decline travel insurance.

21. The method as recited in claim 20, further comprising the step of, generating a database including a summary of information entered during step (C).

22. The method as recited in claim 21, wherein at least one of steps A-D are performed by a travel agency, wherein the database includes a summary of information related to the travel agency.

23. A method for automatically generating a routine during operation of a transaction software application operating on a computer, the steps comprising:
(A) monitoring and capturing transaction data entered into the software application;
(B) identifying a predetermined data sequence in the data entered into the software application;
(C) after step (B), executing a routine offering a sales package related to the transaction software application, wherein the sales package can be accepted or declined; and
(D) if the sales package is accepted at step (C), launching a sales order data entry form and pre-populating the form with previously captured data.

24. The method as recited in claim 23, wherein step (A) further comprises monitoring and capturing keystrokes used to enter data into the software application.

25. The method as recited in claim 24, wherein the keystrokes are monitored and captured via a keyboard interface.

26. The method as recited in claim 25, wherein the transaction data is travel-related data.

27. The method as recited in claim 26, wherein the travel-related data is PNR data.

28. The method as recited in claim 23, wherein step (D) further comprises generating the launching the form locally at the computer.

29. The method as recited in claim 23, wherein step (D) further comprises generating the form remotely at a World Wide Web server over the Internet.

30. The method as recited in claim 23, further comprising the step of populating the transaction software application with data received at the routine.

31. A stored program that is executed on a computer system for facilitating travel insurance sales in parallel with a travel reservation purchase routine, the program configured to:
1) monitor data streams of at least one data sequence relevant to the travel reservation purchasing routine;
2) identify a predetermined data stream in the data sequence;
3) execute a travel insurance purchase routine that A) launches at least one form with data fields that are to be completed related to purchasing travel insurance; and B) populates at least a portion of the data fields with data previously entered during the travel reservation purchase routine; and
4) provide a travel insurance policy.

32. The program as recited in claim 21, wherein the data sequence is input data.

33. The program as recited in claim 32, wherein the data sequence is text data related to a legacy mainframe computer system.

34. The program as recited in claim 33, wherein the computer system includes a processor, a data entry device, and an interface between the entry device and the processor, wherein the stored program monitors data streams via the interface.

35. The program as recited in claim 31, wherein the computer system comprises at least one of a Global Distribution System and a Computer Reservation System.

36. The program as recited in claim 35, wherein data streams further comprise PNR data.

37. The program as recited in claim 31, wherein the stored program is further configured to store the data streams in memory.

38. The program as recited in claim 31, wherein the predetermined data stream indicates a likelihood that a travel reservation will be finalized.

39. The program as recited in claim 31, wherein the stored program is further configured to launch a window offering an option to purchase travel insurance.

40. The program as recited in claim 31, wherein the form is generated locally at the computer system.

41. The program as recited in claim 40, wherein the stored program establishes a connection with a web server over the Internet, and forwards data related to the travel insurance purchase routine to the web server.

42. The program as recited in claim 31, wherein the stored program establishes a connection with a web server over the Internet, and generating the form remotely at the web server.

43. The program as recited in claim 42, wherein the stored program forwards information related to the travel insurance purchase routine to the web server.

44. The program as recited in claim 31, wherein the stored program activates the travel reservation purchase routine after the travel insurance policy is generated.

45. The program as recited in claim 44, wherein data entered during the travel insurance purchase routine is populated into the travel reservation purchase routine.

46. The program as recited in claim 31, wherein the stored program populates data fields with information regarding at least one of 1) an identity of one of the purchasers and 2) details pertaining to the travel reservation.

47. A program to be executed on a computer system for activating a secondary process in parallel with a primary process that receives data, the program configured to:
1) monitor and capture transaction data entered into the software application;
2) identify a predetermined data sequence in the data entered into the software application;
3) execute a routine offering a sales package related to the transaction software application, wherein the sales package can be accepted or declined; and
4) if the sales package is accepted, launch a sales order data entry form and pre-populate the form with previously captured data.

48. The program as recited in claim 47, wherein the stored program monitors and captures keystrokes used to enter data into the software application.

49. The program as recited in claim 48, wherein the keystrokes are monitored and captured via a keyboard interface.

50. The program as recited in claim 49, wherein the transaction data is travel-related data.

51. The program as recited in claim 50, wherein the travel-related data is PNR data.

52. The program as recited in claim 47, wherein the stored program generates the form locally at the computer.

53. The program as recited in claim 47, wherein the stored program generates the form remotely at a World Wide Web server over the Internet.

54. The program as recited in claim 47, wherein the stored program populates the primary process with data received at the secondary process.
